(19) United States
(12) Patent Application Publication
(10) Pub. No.: US 2018/0165537 A1
(43) Pub. Date: Jun. 14, 2018

(54) Systems And Methods Of Biometric Analysis

(71) Applicant: Princeton Identity, Inc., Hamilton, NJ (US)

(72) Inventor: David Alan Ackerman, Hopewell, NJ (US)

(73) Assignee: Princeton Identity, Inc., Hamilton, NJ (US)

(21) Appl. No.: 15/839,020

(22) Filed: Dec. 12, 2017

Related U.S. Application Data
(60) Provisional application No. 62/432,811, filed on Dec. 12, 2016.

(51) Int. Cl. G06K 9/20; G06K 9/00; H04N 5/225; H04N 5/235; H04N 5/353

(52) U.S. Cl. CPC G06K 9/2027; G06K 9/00604; H04N 5/3532; H04N 5/2256; H04N 5/2353; G06K 9/00255

(57) ABSTRACT

Exemplary embodiments are directed to a biometric analysis system including one or more illumination sources, and one or more cameras. The one or more illumination sources are configured to be actuated into an illumination condition to illuminate a subject and a deactivated condition to stop illumination of the subject. The one or more cameras are configured to capture one or more images of the subject. The one or more cameras include a lens, an image sensor, a primary shutter, and a secondary shutter. The secondary shutter can be configured to open in a synchronized manner with actuation of the one or more illumination sources into the illumination condition and close in a synchronized manner with actuation of the one or more illumination sources into the deactivated condition.

### CROSS-REFERENCE TO RELATED APPLICATIONS

The present application claims the benefit of priority to U.S. Provisional Patent Application No. 62/432,811, filed Dec. 12, 2016, which is hereby incorporated by reference in its entirety.

### TECHNICAL FIELD

The present disclosure relates to systems and methods of biometric analysis and, in particular, to biometric analysis systems that capture a reduced amount of ambient light during near infrared (NIR) flash illumination.

### BACKGROUND

Security is a concern in a variety of transactions involving private information. Iris recognition is an example of a well-accepted and accurate means of biometric identification used in government and commercial systems around the world that enables secure transactions and an added layer of security beyond keys and/or passwords. Due to the increased security provided by iris recognition systems, an increase in use of such systems has occurred around the world.

Different types of cameras (global shutter cameras, rolling shutter cameras, or the like) are available in the industry for potential incorporation into biometric identification systems. Global shutter cameras operate in a manner that naturally reduces the integration of ambient light. However, global shutter cameras are generally expensive for use in biometric identification systems. Although rolling shutter cameras are generally inexpensive, use of rolling shutters with a flash involves extended integration times that expose the sensor to large amounts of ambient light. The result is difficulty operating rolling shutter cameras in outdoor environments where a significant amount of ambient light is available.

FIG. 1 is a diagram of activity versus time for operation of an image sensor of a traditional rolling shutter camera. As will be discussed below, traditional rolling shutter cameras provide undesirable results in outdoor environments due to a significant amount of undesired ambient light being captured (e.g., integrated) by the image sensor in the course of using a flash to illuminate a full frame. In normal operation of a rolling shutter camera, each row of pixels 10 is initiated (e.g., zeroed) and starts to gather incoming light which is imaged onto a sensor by a lens during tₑₓₚ. At the end of a preset integration period, the row of pixels 10 is read-out as represented by a read line 12, an operation that takes a finite amount of time. Only one row of pixels 10 can be read out at a time due to limitations of the sensor electronics, in part to keep the cost of the complementary metal-oxide-semiconductor (CMOS) sensor of the rolling shutter low.

To arrange for equal integration times for each row of pixels 10, the initiation and subsequent integration of light in each row of pixels 10 is delayed relative to the preceding row of pixels 10 by one read-time. Particularly, rolling shutter cameras typically expose horizontal lines of pixels 10 in a manner that delays the start of the (N+1)th line relative to the Nth line for a time equal to the read time of the Nth line. In so doing, each subsequent line of pixels 10 is offset by a read time relative to the previous line. With equal integration time for each line of pixels 10, the resulting exposure schedule for the sensor results in different start- and stop-integration times for each line of the sensor. The time to expose the entire sensor is the product of the number of lines N and the read time for each line T plus the integration time for a line Tᵢₙₜ=NT+Tᵢₙₜ. As an example, for a short integration time of approximately 1 ms with a 2000 line sensor with read time of approximately 20 is, the time to expose the entire sensor can be calculated as 2000×20 μs+1 ms=41 ms. Such delay result in the diagonal appearance of the scheduling diagram shown in FIG. 1, and in captured images provides the characteristic shearing of moving objects.

Due to the delay and resulting row scheduling, a flash 14 that illuminates every row of pixels 10 occurs after the bottom row has started integrating but before the top row has finished integrating. The flash 14 occurs during time tₚ between the start and end of a pulse or series of pulses, representing the full frame flash condition. The integration time for each row of pixels 10 should be long enough to create a time when the flash condition can be met. When the total flash 14 brightness is comparable to the ambient light (e.g., during outdoor illumination), every row of pixels 10 can see a significant amount of ambient light. As shown in FIG. 1, Nᵣₐₘₚ₋ᵤₚ represents the number of lines of pixels 10 during a linear transition of flash illumination initiation based on the slope of the row scheduling (m) and the exposure time (τₑₓₚ). Nₚₗₐₜₑₐᵤ represents the number of lines of pixels 10 during a plateau of flash illumination based on the slope of the row scheduling and the difference between the exposure time and flash pulse time (τₚ−τₑₓₚ). During the plateau, the flash persists for the entire integration time. N_{ramp-down} represents the number of lines of pixels 10 during a linear transition as flash illumination is completed based on the slope of the row scheduling and the exposure time (τₑₓₚ).

The rolling shutter effect is analogous to the exposure of a film camera in which first and second mechanical curtains expose the film to incoming light. The first curtain opens when the shutter button is pressed, taking a finite time to fully retract. After a preset exposure time, a second mechanical curtain begins to shut, taking the same time to fully shut as the first curtain took to open. Thus, the two curtains expose each patch of film to the same quantity of light. If an external flash is used, the flash is fired after the first curtain is fully retracted but before the second curtain begins to shut. Failure to fire the flash in this prescribed time period can result in shadowing of the image by the curtains in a way that exposes a portion of the image to ambient light but not the flash light. If the exposure is so short that the second curtain should start closing before the first curtain is fully open, special operational arrangements should be made to create a flash for the entire time that first curtain takes to open such that no shadow is created. A typical minimum exposure time for a mechanical shutter is approximately 3 ms or 4 ms.

With iris biometric devices that use macro ring (MR) flashes to reveal the iris structure used for iris biometric identification, the rolling shutter camera synchronizes the near infrared (NIR) flash to a time after the last line of the sensor has begun to integrate light but before the first line has finished its integration. Failure to meet this condition results in a shadow on the sensor that is analogous to that produced with a mechanical shutter in a film camera. In some cases, shadows are acceptable if a narrowed field of view is acceptable. However, if ambient NIR light is comparable in irradiance on the subject to the flash, the result can be an exposure that is significantly lit by ambient light since the flash is necessarily on for a time that is shorter than the total exposure time. Long exposure to ambient light can produce undesirable effects in the captured image, including but not restricted to motion blur and saturation. Thus, certain lines 16 of pixels 10 (e.g., top and bottom) fail to meet the full (or any) flash condition.

FIG. 2 is a diagram of a “pedestal” effect of ambient light relative to flash illumination for a traditional rolling shutter camera. As noted above, some rows of pixels fail to be illuminated by the flash during operation of the rolling shutter camera. In FIG. 2, sections 18 represent pixels that do not receive illumination from the flash. A linear transition 20 (e.g., Nᵣₐₘₚ₋ᵤₚ of FIG. 1) occurs throughout which rows of pixels receive increasing amounts of flash light, followed by a plateau region 22 (e.g., Nₚₗₐₜₑₐᵤ of FIG. 1) that is properly flashed. After the plateau region 22, a linear transition 24 (e.g., N_{ramp-down} of FIG. 1) occurs back to zero flash light throughout which rows of pixels receive decreasing amounts of flash light. FIG. 2 therefore shows the amount of light that each row of pixels integrates before and after the flash illumination.

When the amount of ambient light is small or zero, the height of the pedestal (ε_{amb}) is small or zero relative to the height of the plateau region 22 produced by the flash illumination (εₚᵤₗₛₑ for irradiance of the pulse of light from the flash). This indicates that the rows in sections 18 are in the dark while only those in the plateau region 22 are lit by the flash light (not by any ambient light). However, when the camera is in an environment with a large amount of ambient light (e.g., outdoors in bright sun, any other region where light gets to the sensor), a pedestal of ambient light (ε_{amb}) exists on top of which is positioned the plateau region 22 for the flash. In some high ambient light environments, the height of the pedestal (ε_{amb}) can be much larger relative to the height of the plateau (εₚᵤₗₛₑ). If the ambient light is bright and/or the time during which the ambient light is collected is long compared to the flash duration, the amount of ambient light collected can be undesirably high compared to the amount of light collected. Ambient NIR light can adversely affect NIR images collected by traditional iris recognition systems.

FIG. 3 is a diagrammatic representation of a traditional rolling shutter camera 30. The camera 30 includes a sensor 32 that receives light from a lens 34 which creates an image 36 on the surface of the sensor 32. Each pixel of the sensor 32 records its portion of the image 36. The light impinging on the sensor 32 is made of both flash and ambient light. Therefore, excessive ambient light can enter the sensor 32 and adversely affect the captured image 36 in certain environments.

FIG. 4 is a flowchart illustrating a process 40 of a traditional rolling shutter camera having a flash and image sensor. At step 42, the first row of pixels is reset and begins to integrate ambient light. At step 44, the next row of pixels begins to integrate ambient light. At step 46, the flash illumination fires and the pixels integrate both ambient light and flash light. At step 48, firing of the flash illumination is completed. At step 50, rows of pixels continue to integrate ambient light until the frame is finished. At step 52, read-out occurs as each row finishes integration of the ambient light and/or the flash light. In high ambient light environments, a significant amount of undesired light can be integrated by the image sensor, adversely affecting the final image.

FIG. 5 is a diagram of pixel line number versus time for operation of an image sensor of a traditional rolling shutter camera with a global start and an NIR flash. Sections 60 represent ambient light in the environment surrounding the camera. The horizontal lines 62 represent pixel lines and suggest the integration times of each pixel line of the image sensor which start globally as indicated by the start frame 64, and end in sequence at line 66 as a consequence of the constraints of the rolling shutter. The NIR flash pulse 68 is represented by a vertical strip having a duration of tₚ starting approximately coincidently with the global start (start frame 64) of integration. The NIR flash 68 ends at point 70 before but close to the stop of integration of the first pixel line, e.g., immediately before the read out of the first pixel line occurring at the read line 72. As shown in FIG. 5, the ambient light illuminates the subject before, during and after the flash 68. Particularly, the remaining pixel lines continue to integrate ambient light until the read line 72 occurs. During operation of such traditional rolling shutter camera that includes global start, the ambient light can overwhelm the flash 68 and the lower portion of the image can be saturated with light.

A need exists for improved biometric analysis systems and rolling shutter cameras that provide means for reducing the amount of ambient light integrated by the image sensor. These and other needs are addressed by the systems and methods of the present disclosure.

### SUMMARY

In accordance with embodiments of the present disclosure, an exemplary biometric analysis system is provided that includes one or more illumination sources (e.g., NIR flash illumination) and one or more cameras (e.g., rolling shutter cameras). The one or more illumination sources are configured to be selectively actuated into an illumination condition to illuminate a subject and a deactivated condition to stop illumination of the subject. The one or more cameras are configured to capture one or more images of the subject. Each of the one or more cameras includes a lens, an image sensor, a primary shutter, and a secondary shutter. The secondary shutter is configured to open in a synchronized manner with actuation of the one or more illumination sources into the illumination condition, and close in a synchronized manner with actuation of the one or more illumination sources into the deactivated condition.

In some embodiments, the one or more illumination sources can be configured to illuminate an iris of the subject. In some embodiments, the one or more illumination sources can be configured to illuminate at least a portion of a face of the subject. The one or more illumination sources can be near infrared flash illumination. In addition to the NIR flash illumination, the one or more illumination sources can be ambient light surrounding the subject and/or the biometric analysis system.

The synchronized manner of opening and closing the secondary shutter provides for a substantially similar amount of time of collection of the near infrared flash illumination and collection of any surrounding ambient light. Particularly, in some embodiments, the secondary shutter is open only during the NIR flash illumination, ensuring that the flash illumination and any ambient light is collected only during the flash time and no additional ambient light is collected before or after the flash.

The biometric analysis system includes a global start configured to synchronize at least one of initiation of exposure and integration of substantially all lines of the image sensor (e.g., all pixel lines) with actuation of the one or more illumination sources into the illumination condition and opening of the secondary shutter. The biometric analysis system is configured to synchronize actuation of the one or more illumination sources into the deactivated condition and closing of the secondary shutter.

The secondary shutter can be configured to close after at least one of a preset exposure time and preset integration time (e.g., a time period between a global start time and a global end time). The global start can be configured to limit exposure of substantially all lines of the image sensor with the secondary shutter during a time period corresponding to the one or more illumination sources in the illumination condition. The image sensor can be configured to read out substantially all lines in a serial manner after closure of the secondary shutter.

In some embodiments, the biometric analysis system can include a processing device in communication with the one or more illumination sources and the one or more cameras. The processing device can be configured to receive as input the one or more images, and analyze the one or more images for biometric data associated with the subject to determine the biometric authenticity of the subject.

In accordance with embodiments of the present disclosure, an exemplary camera for a biometric analysis system including one or more flash illumination sources is provided. The camera includes a lens, an image sensor, a primary shutter, and a secondary shutter. The secondary shutter is configured to open in a synchronized manner with actuation of the one or more flash illumination sources into an illumination condition, and close in a synchronized manner with actuation of the one or more flash illumination sources into a deactivated condition.

In accordance with embodiments of the present disclosure, an exemplary method of operating a biometric analysis system is provided. The method includes actuating one or more illumination sources into an illumination condition to illuminate a subject. The method includes capturing one or more images of the subject with one or more cameras. The one or more cameras include a lens, an image sensor, a primary shutter, and a secondary shutter. Capturing the one or more images of the subject with the one or more cameras includes synchronizing opening of the secondary shutter with actuation of the one or more illumination sources into the illumination condition, and synchronizing closing of the secondary shutter with actuation of the one or more illumination sources into a deactivated condition.

The method includes synchronizing, via a global start, initiation of at least one of exposure and integration of substantially all lines of the image sensor with actuation of the one or more illumination sources into the illumination condition and opening of the secondary shutter. The method includes synchronizing actuation of the one or more illumination sources into the deactivated condition with closing of the secondary shutter. The method includes closing the secondary shutter after at least one of a preset exposure time and a preset integration time. The method includes limiting exposure of substantially all lines of the image sensor with the secondary shutter during a time period corresponding to the one or more illumination sources in the illumination condition.

In accordance with embodiments of the present disclosure, exemplary non-transitory computer-readable medium storing instructions for biometric analysis system operation that are executable by a processing device is provided. Execution of the instructions by the processing device causes the processing device to actuate one or more illumination sources into an illumination condition to illuminate a subject. Execution of the instructions by the processing device causes the processing device to capture one or more images of the subject with one or more cameras. The one or more cameras include a lens, an image sensor, a primary shutter, and a secondary shutter. Capturing the one or more images of the subject with the one or more cameras includes synchronizing opening of the secondary shutter with actuation of the one or more illumination sources into the illumination condition, and synchronizing closing of the secondary shutter with actuation of the one or more illumination sources into a deactivated condition.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed biometric analysis systems and methods, reference is made to the accompanying figures, wherein:

FIG. 1 is a diagram of activity versus time for operation of a prior art rolling shutter camera.

FIG. 2 is a diagram of a “pedestal” effect of ambient light relative to flash illumination for a prior art rolling shutter camera.

FIG. 3 is a diagrammatic representation of a prior art rolling shutter camera.

FIG. 4 is a flowchart illustrating a process of a prior art rolling shutter camera.

FIG. 5 is a diagram of pixel line number versus time for operation of a prior art rolling shutter camera including a global start.

FIG. 6 is a block diagram of an exemplary biometric analysis system in accordance with the present disclosure.

FIG. 7 is a diagram of pixel line number versus time for operation of a camera of an exemplary biometric analysis system in accordance with the present disclosure.

FIG. 8 is a diagrammatic representation of a camera of an exemplary biometric analysis system in accordance with the present disclosure.

FIG. 9 is a flowchart illustrating an exemplary process of implementing an exemplary biometric analysis system in accordance with the present disclosure.

FIG. 10 is a flowchart illustrating an exemplary process of implementing an exemplary biometric analysis system in accordance with the present disclosure.

FIG. 11 are equations and examples representing operation of a traditional rolling shutter camera and a camera of an exemplary biometric analysis system in accordance with the present disclosure.

FIG. 12 is a block diagram of an exemplary computing device for implementing an exemplary biometric analysis system in accordance with the present disclosure.

FIG. 13 is a block diagram of an exemplary biometric analysis system environment in accordance with the present disclosure.

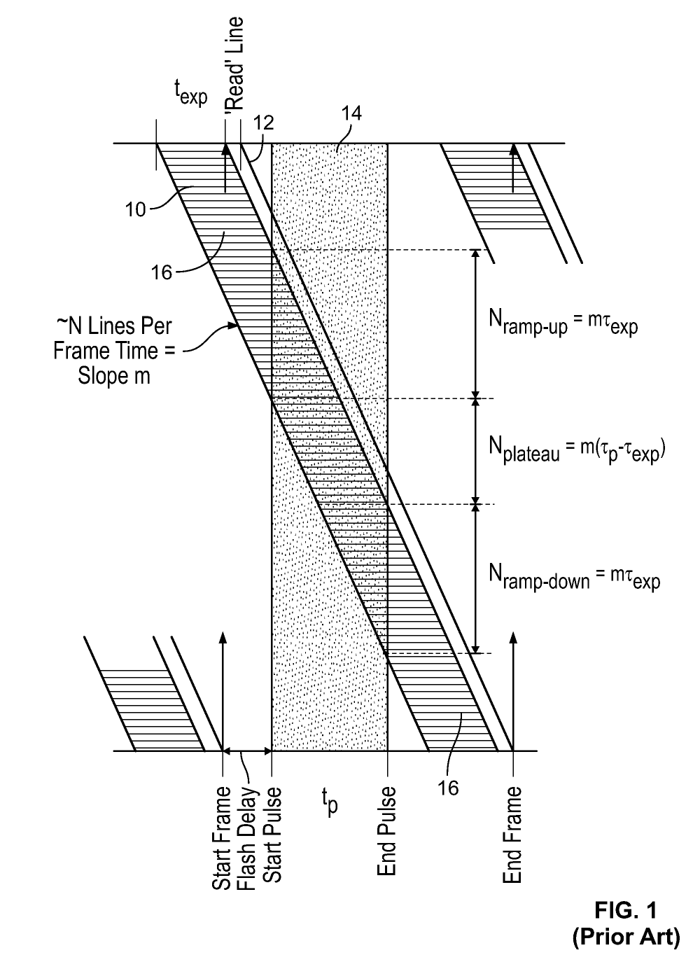

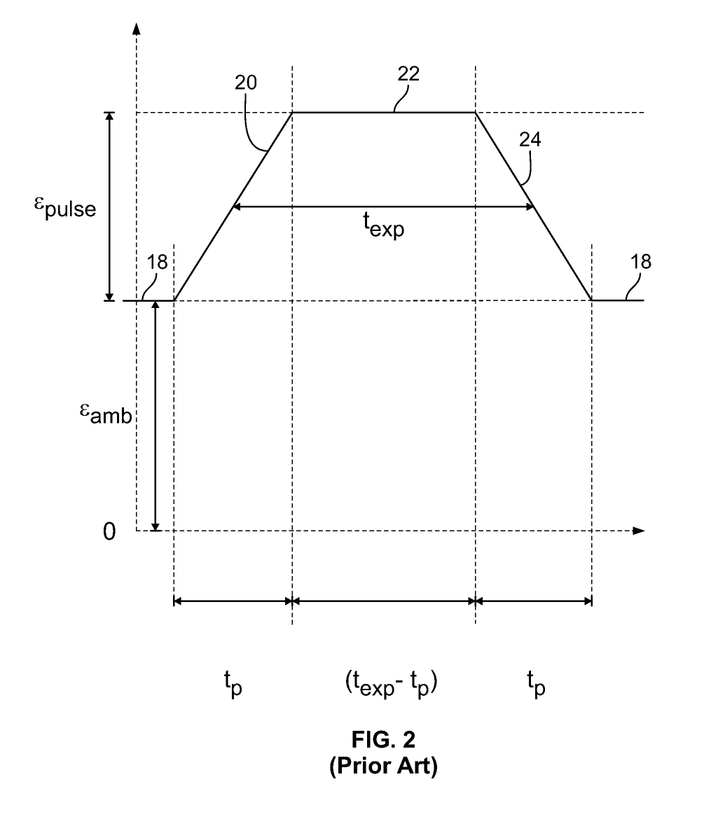

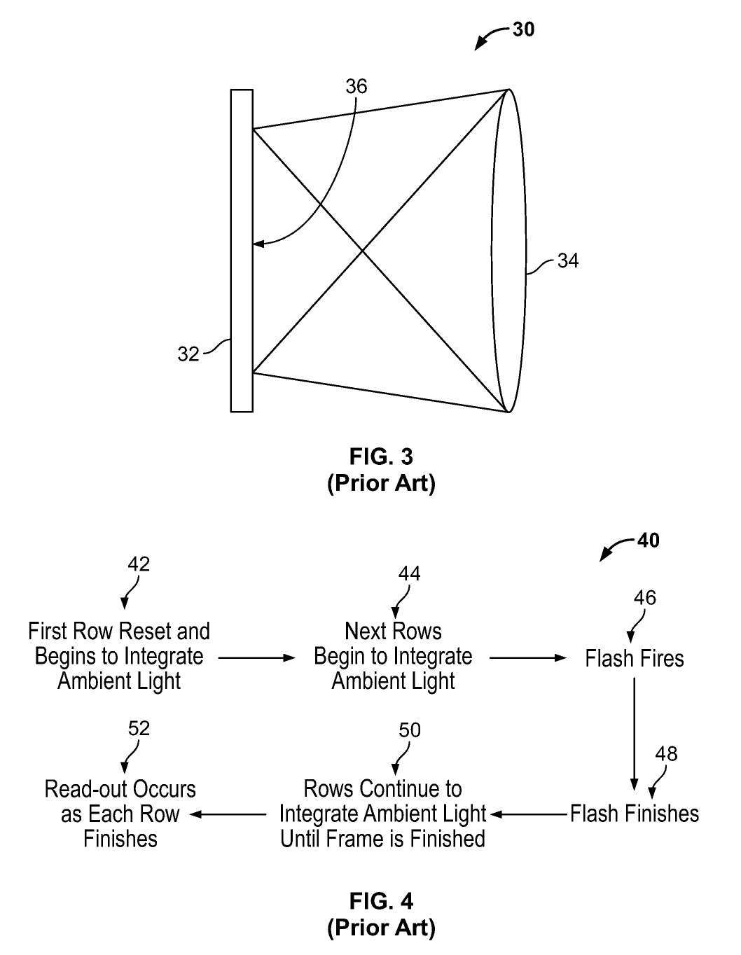

### DESCRIPTION OF EXEMPLARY EMBODIMENTS

In accordance with embodiments of the present disclosure, exemplary biometric analysis systems (and rolling shutter cameras used in such systems) are provided that include means for reducing the amount of ambient light integrated by the image sensor. The image sensor of the camera includes a global start and a secondary shutter which can be synchronized with a flash (e.g., an NIR flash) to reduce the amount of ambient light introduced into and integrated by the sensor.

Particularly, the exemplary camera can be low-cost due to implementation of a rolling shutter camera and is further capable of operating outdoors in a high ambient NIR environment because the camera uses a fast secondary shutter to effectively shield the sensor from excess ambient light. The camera is therefore capable of collecting low-cost NIR images in the presence of ambient NIR light, e.g., outdoors in sunlight, without the adverse effects found in images captured by traditional rolling shutter cameras. In addition, the camera provides the advantages of a low-cost rolling shutter sensor with the optical advantages of a more expensive global shutter camera. The exemplary biometric analysis systems improve image capture in outdoor environments having high levels of ambient light, including but not limited to various civilian and military applications.

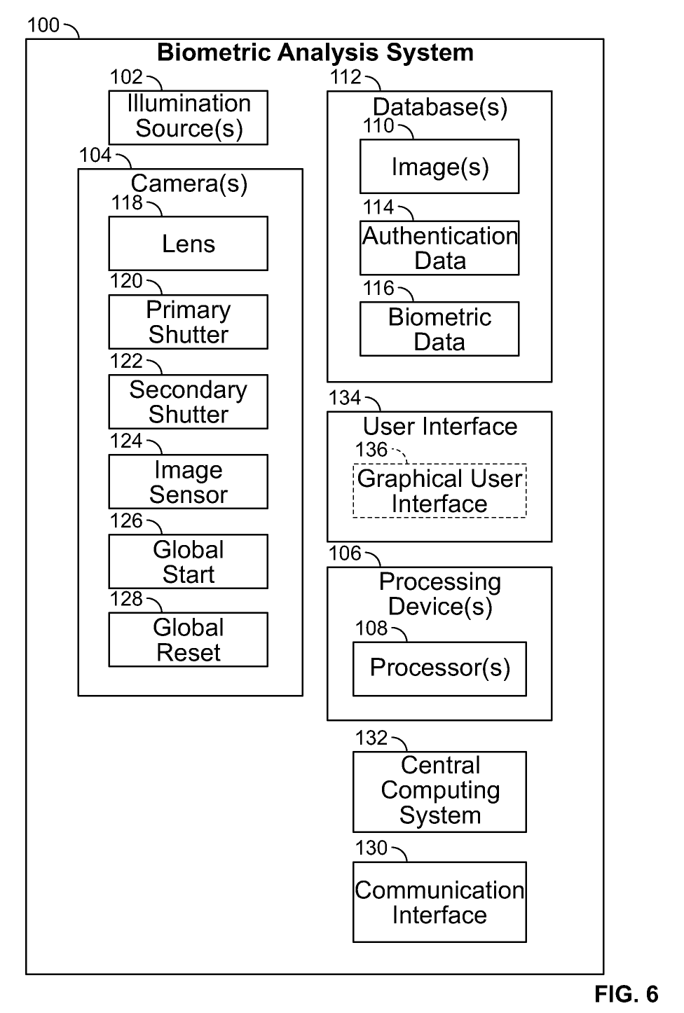

With reference to FIG. 6, a block diagram of an exemplary biometric analysis system 100 (hereafter “system 100”) is provided. The system 100 generally includes one or more illumination sources 102 and one or more cameras 104 (e.g., rolling shutter cameras). The illumination sources 102 includes flash illumination (e.g., NIR flash illumination), and any ambient light surrounding the system 100 (whether NIR ambient light or not). In some embodiments, multiple independent illumination sources 102 can be used to selectively illuminate the iris, face and/or additional portions of the subject. In some embodiments, the illumination sources 102 can be used to illuminate one or more portions of the subject during predetermined or varying time periods, thereby generating periods of darkness and periods of shadows on the face of the subject.

The illumination source 102 can be selectively actuated into an illumination condition to illuminate one or more portions of the subject, and deactivated condition to stop illumination of the subject. For example, the illumination source 102 can be actuated to fire a flash illumination for a predetermined period of time, and further deactivated to stop flash illumination of the subject. The subject is therefore initially illuminated by ambient light (if any), subsequently illuminated by the fired flash illumination from the illumination source 102 to illuminate the subject with flash illumination for a predetermined period of time (tₑₓₚ) in combination with the existing ambient light, and upon deactivation of the flash illumination, the subject can be illuminated by ambient light (if any). In some embodiments, a processing device 106 having one or more processors 108 can synchronize operation of the illumination source 102.

The one or more cameras 104 can be configured to capture one or more images 110 of at least a portion of the subject (such as the iris(es) and/or surrounding regions of the face) during illumination of the subject with the illumination source 102. The captured images 110 can be electronically transmitted to and stored in one or more databases 112. Each image 110 can include or display iris and/or face biometric data associated with the subject, and can be used by the system 100 to determine the biometric authenticity of the subject. In some embodiments, enrollment authentication images can be stored as authentication data 114 in the database 112, along with any additional biometric data 116 associated with the subject.

The camera 104 includes a lens 118, a primary shutter 120 (e.g., an electrical shutter), a secondary shutter 122 (e.g., a fast acting mechanical shutter), and an image sensor 124. The camera 104 includes a global start 126 and a global reset 128. The secondary shutter 122 can be actuated to open in a synchronized manner with actuation of the illumination source 102 (e.g., simultaneously with initiation of flash illumination, during the flash illumination, or the like), and actuated to close in a synchronized manner with actuation of the illumination source 102 into the deactivated condition. The secondary shutter 122 ensures that NIR flash illumination from the illumination source 102 and any ambient light is collected by the image sensor 124 at the same time and for a substantially similar period of time. Particularly, in some embodiments, operation of the secondary shutter 122 is controlled such that the image sensor 124 collects ambient light only during the flash illumination, ensuring that additional undesired ambient light is not collected during capture of the one or more images 110.

Initially, the processing device 106 can actuate the global reset 128 to clear any signals in the pixel lines prior to capture of a new image. Although shown as a separate component of the system 100, in some embodiments, the global reset 128 can be a component of the global start 126. In some embodiments, the global start 126 can perform the function of the global reset 128 prior to capture of an image. To ensure proper operation of the secondary shutter 122, the global start 126 can be actuated (e.g., by the processing device 106) to synchronize initiation of at least one of exposure and integration of substantially all lines of the image sensor 124 with actuation of the illumination source 102 into the illumination condition and opening of the secondary shutter 122. As used herein, the term exposure includes reference to the act of allowing flash illumination to hit the image sensor 124, and the term integration includes reference to the addition or intake of signals with the image sensor 124 during exposure of the pixels. In some embodiments, integration of all lines can be initiated immediately before or at the same time as actuation of the illumination source 102 into the illumination condition and opening of the secondary shutter 122. Actuation of the illumination source into the illumination condition and opening of the secondary shutter 122 can therefore occur substantially simultaneously. In some embodiments, upon initiation of the flash illumination from the illumination source 102, the global start 126 can actuate the exposure of the pixel lines in the image sensor 124 and open the secondary shutter 122.

The processing device 106 can synchronize actuation of the illumination source 102 into the deactivated condition and closing of the secondary shutter 122. For example, the illumination source 102 can be actuated into the deactivated condition and the secondary shutter 122 can be closed immediately before read out of the first pixel line begins. Thus, upon stopping of the flash illumination from the illumination source 102, the secondary shutter 122 can be closed, ensuring that additional ambient light does not enter the image sensor 124. In some embodiments, the illumination source 102 can be actuated into the deactivated condition first, and the secondary shutter 122 is closed immediately after to reduce the amount of ambient light entering the image sensor 124.

The synchronized manner of operation can be based on a predetermined or preset exposure/integration time. Such time can be calculated as the time between a global start time (e.g., the time when exposure begins) and a global end time (e.g., the time when exposure ends). Such time can correspond substantially with the time period of the flash illumination. The secondary shutter 122 is therefore controlled to limit any flash and ambient light collection to the exposure time. After the exposure time is completed and the secondary shutter 122 is closed, the image sensor 124 can read out all pixel lines in a serial manner. Read-out of all pixel lines can therefore begin after the flash illumination is completed, and immediately before or immediately after closure of the secondary shutter 122.

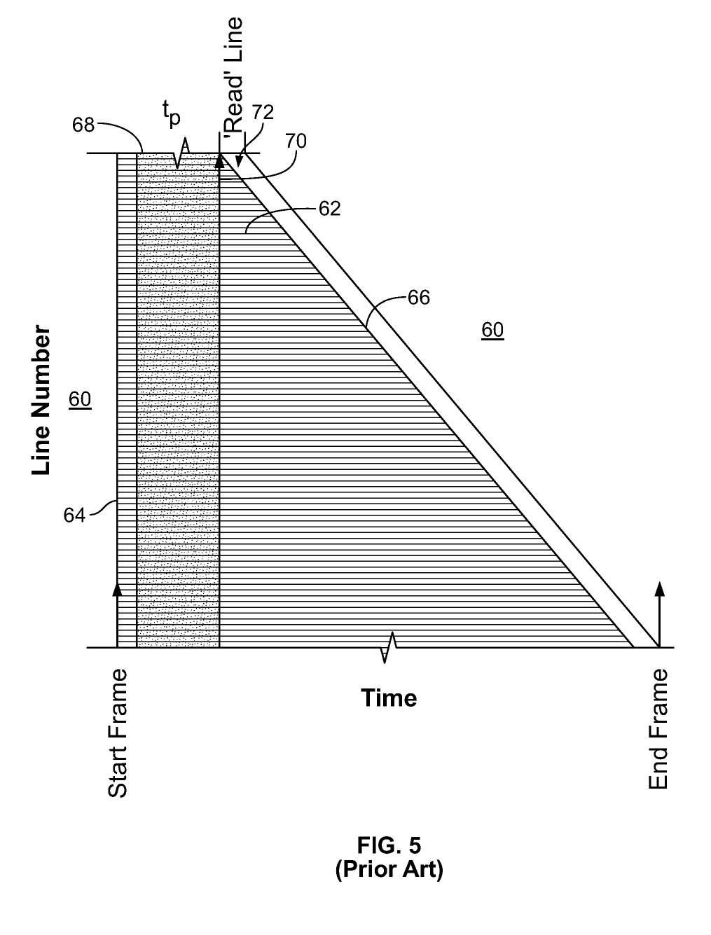

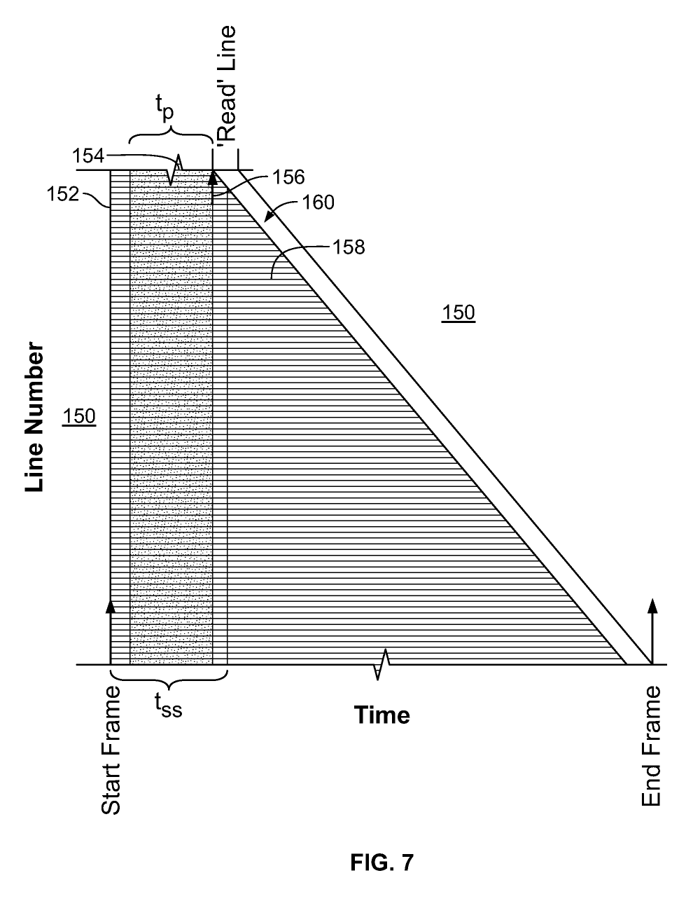

With reference to FIG. 7, a diagram of pixel line number versus time for operation of the exemplary camera 104 is provided to illustrate the synchronized operation of the exemplary system 100 as compared to the prior art system operation shown in FIG. 5. Although sections 150 represent ambient light in the environment surrounding the camera 104, in some embodiments, such ambient light is only integrated by the image sensor 124 during a time (tₛₛ) between which the secondary shutter 122 is opened and closed. Particularly, operation of the secondary shutter 122 reduces the amount of time when ambient light is integrated by the image sensor 124 (as compared to integration of the additional ambient light in traditional cameras shown in FIG. 5). The ambient light integration time is limited at its beginning by the later of the opening of the secondary shutter 122 and the global start 126, and at its end by the close of the secondary shutter 122 (assuming that the close of the secondary shutter 122 occurs before or at the end of the integration of the first line (top line) of the pixel lines 158.

The system 100 ensures that operation of the secondary shutter 122 is synchronized with operation of the flash illumination. As shown in FIG. 7, the global start 126 initiates integration of all pixel lines at the start frame 152. The global start 126 synchronizes integration of all pixel lines with opening of the secondary shutter 122 to be at substantially the same time. The time tₛₛ therefore begins at substantially the same time as the start frame 152. The global start 126 further synchronizes initiation of the flash illumination 154 with the start frame 152. The flash illumination 154 continues for a time tₑₓₚ. In some embodiments, the flash illumination 154 is initiated at the same time as the start frame 152 and opening of the secondary shutter 122. In some embodiments, the flash illumination 154 is initiated coincidentally with opening of the secondary shutter 122 such that the time tₑₓₚ of the flash illumination 154 is substantially similar to the time tₛₛ. In some embodiments, the time tₑₓₚ of the flash illumination 154 can be shorter than the time tₛₛ when the secondary shutter 122 is open.

The flash illumination 154 is stopped at a point 156 immediately before (but close to) the stop of integration of the first pixel line of the multiple pixel lines 158. The secondary shutter 122 is synchronized to close at the same time as stopping the flash illumination 154 or immediately thereafter. The point of closure of the secondary shutter 122 is represented by the end of the time period tₛₛ. Reading of the pixel lines 158 occurs at the read line 160. Although integration of the remaining pixel lines 158 continues after the secondary shutter 122 has been closed, ambient light no longer reaches the image sensor 124 and is no longer integrated by the image sensor 124 due to closure of the secondary shutter 122. Therefore, in some embodiments, the secondary shutter 122 only allows for integration of ambient light substantially during the time period of flash illumination 154, and reduces the additional ambient light integrated when flash illumination 154 is not occurring. The primary shutter 120 can be closed at any point after closure of the secondary shutter 122. It should be understood that even with the primary shutter 120 open, because the secondary shutter 122 has been closed, ambient light is no longer integrated by the image sensor 124. The resulting illuminated image stands out above the ambient light and the entire frame is evenly lit, mainly by the applied flash illumination 154.

Still with reference to FIGS. 6 and 7, the camera 104 combines a low-cost rolling shutter with the global start 126 and a fast secondary shutter 122. The global start 126 starts substantially all lines of an exposure in synchrony with an external flash from the illumination source 102 and opening of the secondary shutter 122. The fast secondary shutter 122 terminates the exposure of substantially all lines of the image sensor 124 in synchrony with the ending of the flash illumination. In so doing, the image sensor 124 is exposed for a period of time substantially limited to that of the external flash, thereby reducing the integration of ambient NIR light.

In contrast to traditional rolling shutter cameras, the exemplary camera 104 includes an image sensor 124 that initiates (zeroes) each and every row of pixels at one time and immediately after that, each and every row of pixels starts integrating. As soon as the rows of pixels start integrating, the secondary shutter 122 opens giving the rolling shutter sensor 124 something to integrate. This action corresponds with when the flash illumination fires. After a preset exposure time and after the flash firing is completed, the secondary shutter 122 closes, leaving the sensor 124 in the dark. Integration of undesired ambient light is thereby prevented with the secondary shutter 122 (even if the primary shutter 120 remains open).

After the secondary shutter 122 closes, the sensor 124 can be actuated to start reading out rows of pixels, e.g., starting with the first row and then reading the second row, third row, and so on, until the entire sensor 124 is read out. In this manner, the sensor 124 collects flash light and ambient light for substantially the same amount of time. If the flash light is comparable to or brighter than the ambient light, the problem of collecting too much ambient light is mitigated by closure of the secondary shutter 122 in a synchronized manner with the flash firing.

The secondary shutter 122 can be mechanical, electronic, or combinations of both. In some embodiments, the secondary shutter 122 can include a liquid crystal light modulator, an electronically tunable lens, or the like. As noted above, substantially all lines begin to integrate light at the same time. With traditional cameras, integrating light at the same time is undesirable when ambient light is present because the (N+1)th line is open longer than the Nth line, and therefore appears brighter. With ambient light present, an image created using a global start and a rolling shutter results in an undesirable brightness gradient from top to bottom. The secondary shutter 122 mitigates such gradient problems by stopping integration of the entire sensor 124 after a preset time following the global start. The (N+1)th line integrates for a longer time than the Nth line, but both the Nth and (N+1)th lines are blocked from receiving any light by the fast secondary shutter 122 such that no gradient in brightness occurs.

The fast secondary shutter 122 can include mechanical curtains as used in film and digital single-lens reflex (DSLR) cameras, rotating mechanical shutters as used in some video cameras, optical light choppers, liquid crystal screens that can be set to transmit some portion of incident light or block essentially all incident light, or other opto-electronic devices that can divert or reflect incident light from impinging on the sensor. The type of fast secondary shutter 122 used can depend on the specific design requirements of the camera 104. In addition to the examples discussed above, it should be understood that any other device that can quickly open and close to admit and then block incident light can be used. The type of secondary shutter 122 selected can be dependent on, e.g., cost, physical size, required power, long-term reliability, combinations thereof, or the like.

The meaning of the term “fast” when used herein in reference to a fast secondary shutter 122 (as compared to the primary shutter 120) is used in comparison to the time it takes for the rolling shutter 122 to read out all of the lines. For a read time T and a sensor with N lines, the time period can be calculated as NT. For example, with 2000 lines and a 20 μs read time, the time period for a traditional shutter can be NT=40 ms. A fast secondary shutter 122 can be configured to close in a fraction of 1 ms.

Synchronization with a NIR flash (e.g., the illumination source 102) can follow the following steps. To begin, the secondary shutter 122 is activated by an external signal, e.g., the press of a shutter button. Substantially all lines of the rolling shutter start to integrate simultaneously. The NIR flash begins to fire at the same time that the lines of the image sensor 124 begin to integrate. The MR flash turns off after a preset time, e.g., 1 ms. Immediately after the NIR flash is actuated off, the fast secondary shutter 122 closes, thereby blocking ambient light from all of the lines in the sensor 124. Each line in the sensor 124 completes its integration in a serial fashion in the dark (behind the fast secondary shutter 122) with the exposure completing when the last line reads out. The total exposure to light (flash and ambient) can therefore be controlled to be 1 ms, for example, while the total sensor readout time can be as long as needed, e.g., 40 ms.

The system 100 can include a communication interface 130 configured to provide for a communication network between components of the system 100, thereby allowing data to be transmitted and/or received by the components of the system 100. For example, the communication interface 130 can transmit data between the illumination sources 102 and cameras 104. In some embodiments, the processing device 106 can receive the data captured by the camera 104 and electronically transmits such captured data to a central computing system 132 for analysis and processing. The processing device 106 can be programmed to control the synchronized operation of the camera 104 and illumination source 102, receives as input camera imagery, analyzes the camera imagery, and contributes to the determination of whether the subject is authenticated.

The system 100 includes a user interface 134. In some embodiments, the user interface 134 can include a display in the form of a graphical user interface (GUI) 136. In some embodiments, the interface 134 can include a numerical (or alphanumerical display), a scanner, a microphone, the illumination sources 102, the cameras 104, combinations thereof, or the like. Instructions for properly using the system 100 can be provided to the user via the GUI 136. The GUI 136 can include one or more displays/indicators for communicating information to the subject, and can be local to or remote from the illumination sources 102 and/or the cameras 104.

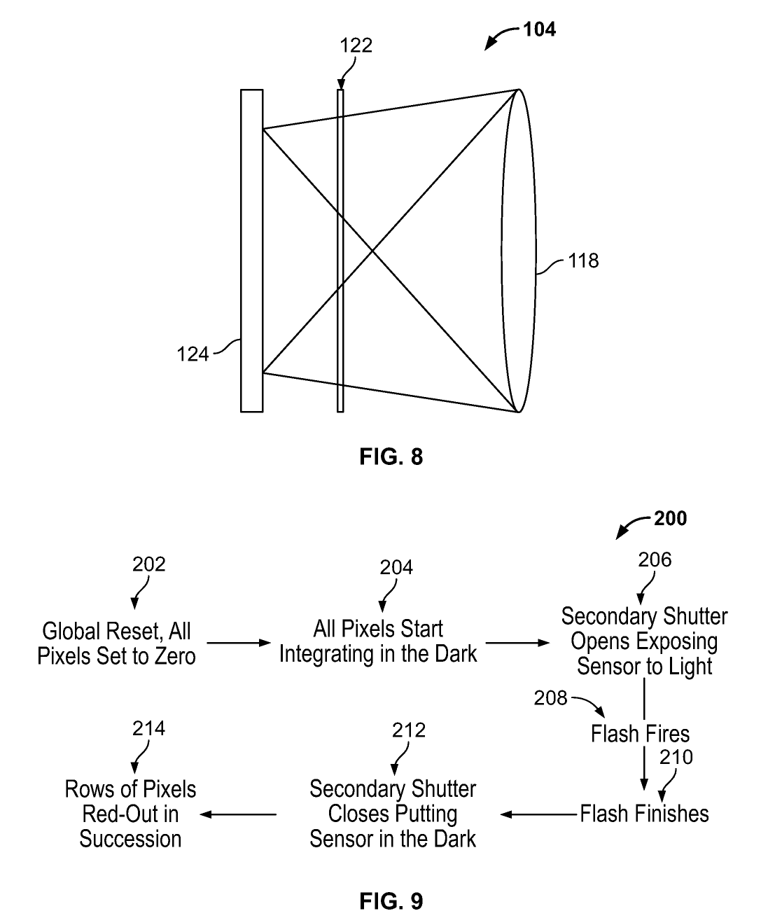

FIG. 8 is a diagrammatic representation of the camera 104 of the system 100, including the lens 118, the secondary shutter 122, and the image sensor 124. The secondary shutter 122 is therefore disposed between the lens 118 and the sensor 124. As noted above, the secondary shutter 122 can be either mechanical, electronic, or both. In some embodiments, the secondary shutter 122 can be electronic in the form of a liquid crystal (LC) shutter designed to accommodate the range of rays emerging from the imager-side of the lens 118. In a closed state, the LC shutter can be opaque, while in an open state the LC shutter can be substantially transparent. The ratio of transmissivity in the open to closed states is the extinction ratio which can be high.

In some embodiments, the secondary shutter 122 can be disposed in a position just in front of the image sensor 124. In some embodiments, the secondary shutter 122 can be disposed within the lens 118 of the camera 104. A shutter 122 designed to deflect or reflect light that is built into lens 118, e.g., at the lens 118 pupil, may not change the overall size of the camera 104. A shutter 122 positioned in front of the image sensor 124 can be incorporated into the camera 104 itself (rather than the lens 118). If such a shutter 122 used polarizers, the camera 104 may operate despite the loss of light incurrent in the shutter 122.

FIG. 9 is a flowchart illustrating an exemplary process 200 of implementing the system 100, particularly the image sensor 124 of the system 100. To begin, at step 202, all pixels of the image sensor 124 are reset to zero with the global reset 128. At step 204, all pixels being integrating in the dark (e.g., prior to the flash illumination) as initiated by the global start 126. At step 206, the secondary shutter 122 is opened, exposing the image sensor 124 to ambient light. At step 208, the flash is fired by the illumination source 102. At step 210, firing of the flash with the illumination source 102 is completed. At step 212, the secondary shutter 122 is closed, placing the image sensor 124 in the dark. At step 214, the rows of pixels read-out in succession. The secondary shutter 122 can therefore be actuated to open in a synchronized manner relative to firing of the flash, e.g., open immediately before firing of the flash, and close immediately after firing of the flash is completed.

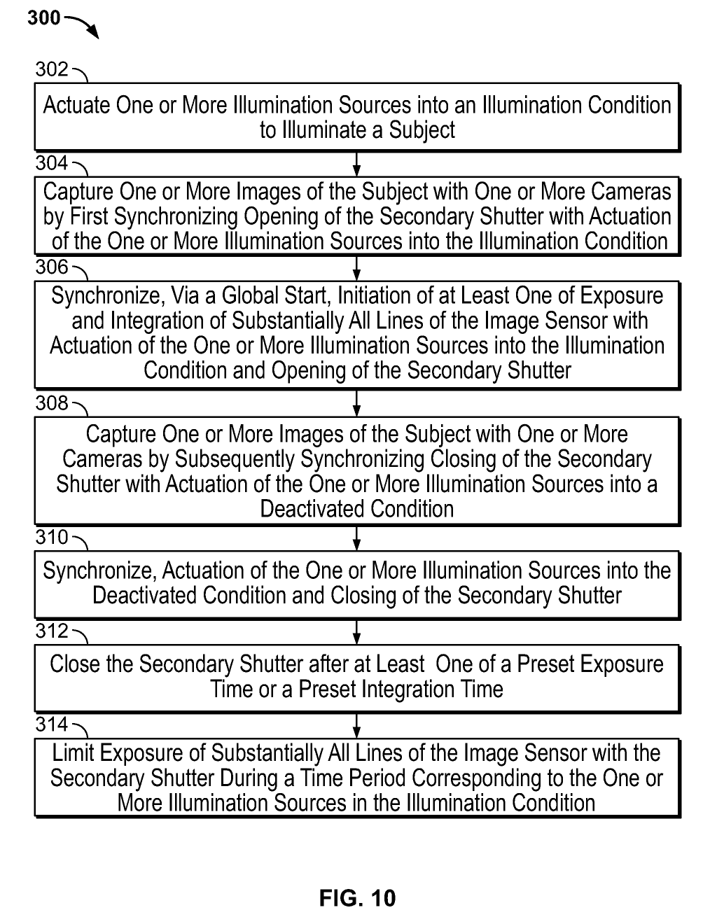

FIG. 10 is a flowchart illustrating an exemplary process 300 of implementing the system 100. To begin, at step 302, one or more illumination sources are actuated into an illumination condition to illuminate a subject (e.g., the flash illumination is fired). At step 304, one or more images of the subject are captured with one or more cameras by first synchronizing opening of the secondary shutter with actuation of the one or more illumination sources into the illumination condition. At step 306, the synchronization can be performed by a global start that initiates at least one of exposure and integration of substantially all lines of the image sensor with actuation of the illumination sources into the illumination condition and opening of the secondary shutter. For example, the global start can begin exposure of substantially all lines immediately prior to opening of the secondary shutter, and the secondary shutter can be opened immediately prior to filing of the flash.

At step 308, the one or more images of the subjects can be captured by the cameras by synchronizing closing of the secondary shutter with actuation of the illumination sources into a deactivated condition. At step 310, the synchronization can be performed by a processing device that actuates the illumination sources into the deactivated condition and closes the secondary shutter. For example, the processing device can first stop firing of the flash illumination, immediately thereafter closes the secondary shutter.

At step 312, the secondary shutter can be closed after at least one of a preset exposure time or a preset integration time (e.g., the timing between opening and closing of the secondary shutter can be preset based on the time for integration of the first line of pixels). At step 314, exposure of substantially all lines of the image sensor can be limited by the secondary shutter (or the global reset) during a time period corresponding to the illumination sources in the illumination condition. Thus, exposure of the lines and the open condition of the secondary shutter corresponds substantially with the time when the flash illumination occurs, ensuring that in some embodiments the lines of the image sensor are exposed only during the flash illumination. Thus, in some embodiments, minimal ambient light is collected only during the flash illumination, and additional ambient light collection before and after flash illumination is prevented.

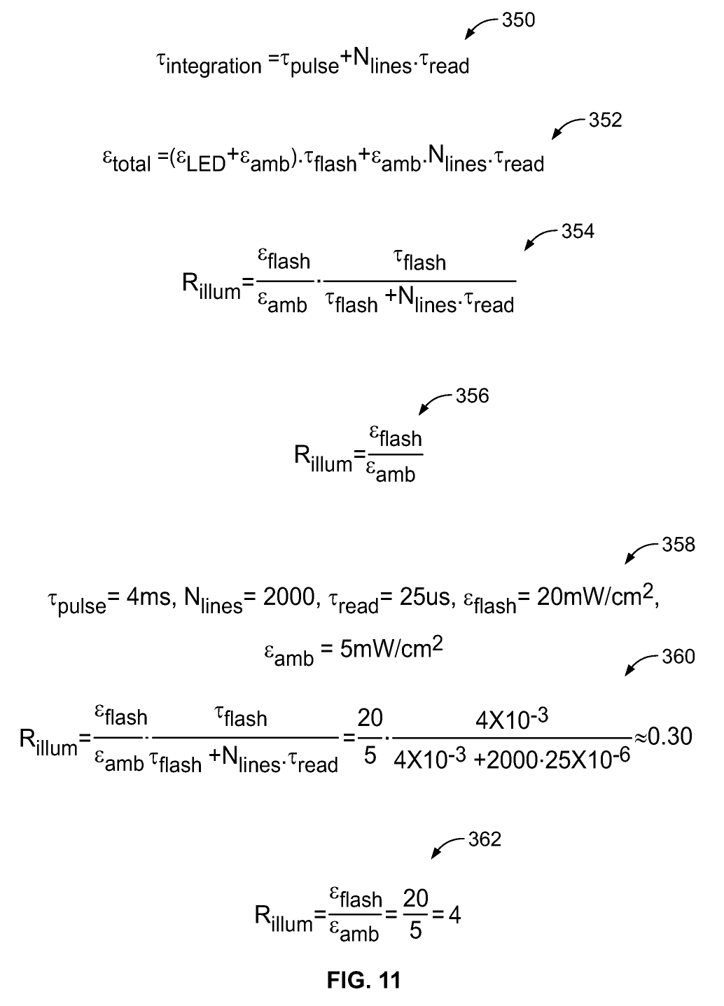

FIG. 11 shows various equations and examples of operation of traditional and exemplary cameras of biometric analysis systems. The equations of FIG. 11 support the numerical calculations discussed throughout the present disclosure. The equations of FIG. 11 further quantify the expected improvement resulting by implementation of the exemplary system 100 as compared to traditional biometric analysis systems, by assigning reasonable numbers to simple formulas for the relevant times and to the ratio of wanted flash light to unwanted ambient light in the traditional and exemplary systems. Equation 350 represents the total time (τ_{integration}) for integration under operation of a traditional biometric analysis system camera, with Tₚᵤₗₛₑ representing the time for the flash pulse, Nₗᵢₙₑₛ representing the number of pixel lines, and τ_{read} representing the time for read-out.

Equation 352 represents the total irradiance (εₜₒₜₐₗ) integrated during integration, with ε_{LED} representing ambient light from light-emitting diodes (LEDs), ε_{amb} representing any additional ambient light, τ_{flash} representing the time for flash illumination, Nₗᵢₙₑₛ representing the number of pixel lines, and τ_{read} representing the time for read-out. Equation 354 represents the ratio (Rᵢₗₗᵤₘ) of flash to ambient light integrated by the sensor, with ε_{flash} representing the amount of light from flash illumination, ε_{amb} representing any ambient light, τ_{flash} representing the time for flash illumination, Nₗᵢₙₑₛ representing the number of pixel lines, and τ_{read} representing the time for read-out. Equation 356 represents the ration (Rᵢₗₗᵤₘ) when the flash and integration time are equal, with ε_{flash} representing the amount of light from flash illumination, and ε_{amb} representing any ambient light.

Example 358 provides values for the time of flash illumination, the number of pixel lines, the time for read-out, the amount of flash illumination, and the amount of ambient light. Using Equation 354 and the values from Example 358, Calculation 360 shows the ratio of flash to ambient light integrated for a traditional camera as approximately 0.30. Calculation 360 indicates that the amount of flash light integrated is low for traditional cameras. In contrast, using Equation 356 and the values from Example 358, Calculation 362 shows the ratio of flash to ambient light integrated for an exemplary camera as approximately 4. Calculation 362 indicates that the amount of flash light integrated for the exemplary camera is much larger than for the traditional camera, resulting in less undesired ambient light from being collected.

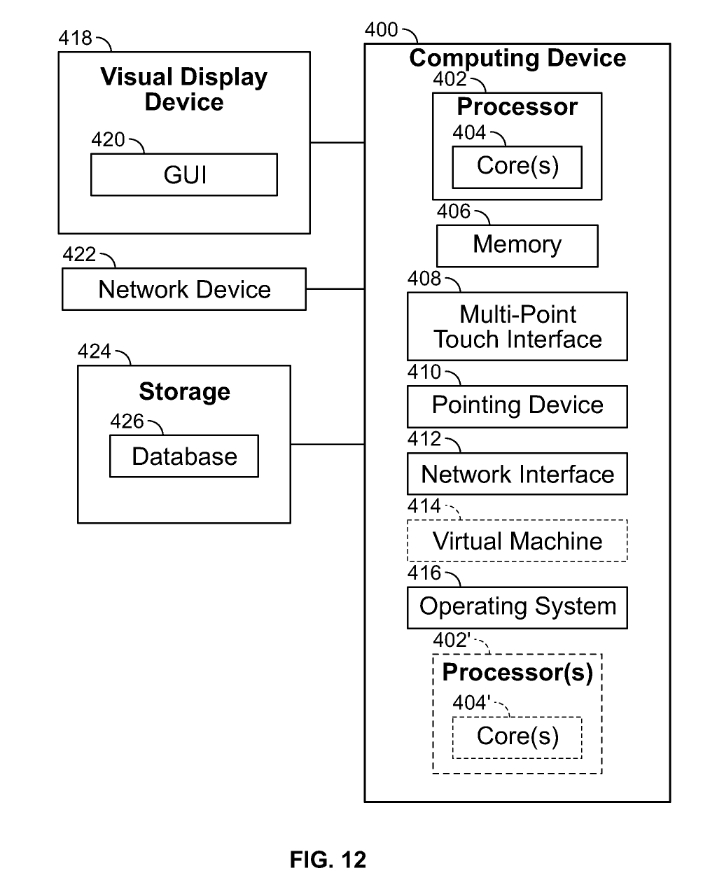

FIG. 12 is a block diagram of a computing device 400 in accordance with exemplary embodiments of the present disclosure. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 406 included in the computing device 400 may store computer-readable and computer-executable instructions or software for implementing exemplary embodiments of the present disclosure (e.g., instructions for operating the illumination sources, instructions for operating the processing device, instructions for operating the cameras, instructions for operating the communication interface, instructions for operating the user interface, instructions for operating the central computing system, combinations thereof, or the like). The computing device 400 also includes configurable and/or programmable processor 402 and associated core 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ may each be a single core processor or multiple core (404 and 404′) processor.

Virtualization may be employed in the computing device 400 so that infrastructure and resources in the computing device 400 may be shared dynamically. A virtual machine 414 may be provided to handle a process running on multiple processors so that the process appears to be using only one computing resource rather than multiple computing resources. Multiple virtual machines may also be used with one processor. Memory 406 may include a computer system memory or random access memory, such as DRAM, SRAM, EDO RAM, and the like. Memory 406 may include other types of memory as well, or combinations thereof.

A user may interact with the computing device 400 through a visual display device 418 (e.g., a personal computer, a mobile smart device, or the like), such as a computer monitor, which may display one or more user interfaces 420 (e.g., a graphical user interface) that may be provided in accordance with exemplary embodiments. The computing device 400 may include other I/O devices for receiving input from a user, for example, a camera, a keyboard, a scanner, microphone, or any suitable multi-point touch interface 408, a pointing device 410 (e.g., a mouse). The keyboard 408 and the pointing device 410 may be coupled to the visual display device 418. The computing device 400 may include other suitable conventional I/O peripherals.

The computing device 400 may also include one or more storage devices 424, such as a hard-drive, CD-ROM, eMMC (MultiMediaCard), SD (secure digital) card, flash drive, non-volatile storage media, or other computer readable media, for storing data and computer-readable instructions and/or software that implement exemplary embodiments of the multi-modal biometric analysis systems described herein. Exemplary storage device 424 may also store one or more databases 426 for storing any suitable information required to implement exemplary embodiments. For example, exemplary storage device 424 can store one or more databases 426 for storing information, such as data relating to images, authentication data, biometric data, combinations thereof, or the like, and computer-readable instructions and/or software that implement exemplary embodiments described herein. The databases 426 may be updated by manually or automatically at any suitable time to add, delete, and/or update one or more items in the databases.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 may include a built-in network adapter, network interface card, PCMCIA network card, PCI/PCIe network adapter, SD adapter, Bluetooth adapter, card bus network adapter, wireless network adapter, USB network adapter, modem or any other device suitable for interfacing the computing device 400 to any type of network capable of communication and performing the operations described herein. Moreover, the computing device 400 may be any computer system, such as a workstation, desktop computer, server, laptop, handheld computer, tablet computer (e.g., the tablet computer), mobile computing or communication device (e.g., the smart phone communication device), an embedded computing platform, or other form of computing or telecommunications device that is capable of communication and that has sufficient processor power and memory capacity to perform the operations described herein.

The computing device 400 may run any operating system 416, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 416 may be run in native mode or emulated mode. In an exemplary embodiment, the operating system 416 may be run on one or more cloud machine instances.

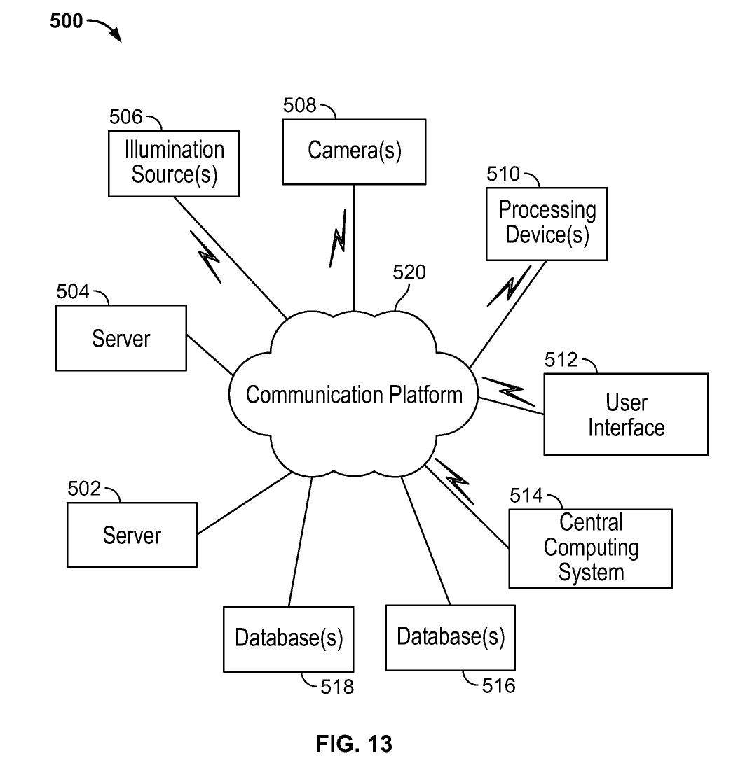

FIG. 13 is a block diagram of an exemplary biometric analysis system environment 500 in accordance with exemplary embodiments of the present disclosure. The environment 500 can include servers 502, 504 configured to be in communication with one or more illumination sources 506, one or more cameras 508, processing devices 510, a user interface 512, and a central computing system 514 via a communication platform 520, which can be any network over which information can be transmitted between devices communicatively coupled to the network. For example, the communication platform 520 can be the Internet, Intranet, virtual private network (VPN), wide area network (WAN), local area network (LAN), and the like. In some embodiments, the communication platform 520 can be part of a cloud environment.

The environment 500 can include repositories or databases 516, 518, which can be in communication with the servers 502, 504, as well as the illumination sources 506, one or more cameras 508, processing devices 510, the user interface 512, and the central computing system 514, via the communications platform 520. In exemplary embodiments, the servers 502, 504, the illumination sources 506, one or more cameras 508, processing devices 510, the user interface 512, and the central computing system 514 can be implemented as computing devices (e.g., computing device 400). Those skilled in the art will recognize that the databases 516, 518 can be incorporated into one or more of the servers 502, 504. In some embodiments, the databases 516, 518 can store data relating to images, authentication data, biometric data, combinations thereof, or the like, and such data can be distributed over multiple databases 516, 518.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A biometric analysis system, comprising:
one or more illumination sources configured to be actuated into an illumination condition to illuminate a subject and a deactivated condition to stop illumination of the subject;
one or more cameras configured to capture one or more images of the subject, the one or more cameras including:
a lens;
an image sensor;
a primary shutter; and
a secondary shutter configured to open in a synchronized manner with actuation of the one or more illumination sources into the illumination condition and close in a synchronized manner with actuation of the one or more illumination sources into the deactivated condition.

2. The biometric analysis system of claim 1, wherein the one or more illumination sources are configured to illuminate an iris of the subject.

3. The biometric analysis system of claim 1, wherein the one or more illumination sources are configured to illuminate at least a portion of a face of the subject.

4. The biometric analysis system of claim 1, wherein the one or more illumination sources are near infrared flash illumination.

5. The biometric analysis system of claim 4, wherein the synchronized manner of opening and closing the secondary shutter provides for a substantially similar amount of time of collection of the near infrared flash illumination and collection of any ambient light.

6. The biometric analysis system of claim 1, comprising a global start configured to synchronize initiation of at least one of exposure and integration of substantially all lines of the image sensor with actuation of the one or more illumination sources into the illumination condition and opening of the secondary shutter.

7. The biometric analysis system of claim 6, wherein the synchronized manner comprises synchronized actuation of the one or more illumination sources into the deactivated condition and closing of the secondary shutter.

8. The biometric analysis system of claim 7, wherein the secondary shutter is configured to close after at least one of a preset exposure time or a preset integration time.

9. The biometric analysis system of claim 8, wherein at least one of the preset exposure time or the preset integration time is a time period between a global start time and a global end time.

10. The biometric analysis system of claim 1, comprising a global start configured to limit exposure of substantially all lines of the image sensor with the secondary shutter during a time period corresponding to the one or more illumination sources in the illumination condition.

11. The biometric analysis system of claim 8, wherein the image sensor is configured to read out substantially all lines in a serial manner after closure of the secondary shutter.

12. The biometric analysis system of claim 1, comprising a processing device in communication with the one or more illumination sources and the one or more cameras.

13. The biometric analysis system of claim 12, wherein the processing device is configured to receive as input the one or more images, and analyze the one or more images for biometric data associated with the subject to determine the biometric authenticity of the subject.

14. A camera for a biometric analysis system including one or more flash illumination sources, the camera comprising:
a lens;
an image sensor;
a primary shutter; and
a secondary shutter configured to open in a synchronized manner with actuation of the one or more flash illumination sources into an illumination condition and close in a synchronized manner with actuation of the one or more flash illumination sources into a deactivated condition.

15. A camera of claim 14, in combination with the at least one or more flash illumination sources.

16. A method of operating a biometric analysis system, comprising:
actuating one or more illumination sources into an illumination condition to illuminate a subject; and
capturing one or more images of the subject with one or more cameras, the one or more cameras including:
a lens;
an image sensor;
a primary shutter; and
a secondary shutter,
wherein capturing the one or more images of the subject with the one or more cameras comprises:
synchronizing opening of the secondary shutter with actuation of the one or more illumination sources into the illumination condition; and
synchronizing closing of the secondary shutter with actuation of the one or more illumination sources into a deactivated condition.

17. The method of claim 16, comprising synchronizing, via a global start, initiation of at least one of exposure and integration of substantially all lines of the image sensor with actuation of the one or more illumination sources into the illumination condition and opening of the secondary shutter.

18. The method of claim 17, comprising synchronizing actuation of the one or more illumination sources into the deactivated condition with closing of the secondary shutter.

19. The method of claim 18, comprising closing the secondary shutter after at least one of a preset exposure and a preset integration time.

20. A non-transitory computer-readable medium storing instructions for biometric analysis system operation that are executable by a processing device, wherein execution of the instructions by the processing device causes the processing device to:
actuate one or more illumination sources into an illumination condition to illuminate a subject;
capture one or more images of the subject with one or more cameras, the one or more cameras including:
a lens;
an image sensor;
a primary shutter; and
a secondary shutter,
wherein capturing the one or more images of the subject with the one or more cameras comprises:
synchronizing opening of the secondary shutter with actuation of the one or more illumination sources into the illumination condition; and
synchronizing closing of the secondary shutter with actuation of the one or more illumination sources into a deactivated condition.
